(19) United States
(12) Patent Application Publication
(10) Pub. No.: US 2005/0283758 A1
(43) Pub. Date: Dec. 22, 2005

(54) Bi-directional programming system/method for program development

(75) Inventors: Garrick Cobcroft, Mitchelton (AU); Dhiraj Bhandari, Lucia (AU)

Correspondence Address: DARBY & DARBY P.C., P. O. BOX 5257, NEW YORK, NY, 10150-5257, US

(73) Assignee: INTERAD TECHNOLOGY LIMITED, West End (AU)

(21) Appl. No.: 11/046,223

(22) Filed: Jan. 28, 2005

Related U.S. Application Data
(63) Continuation of application No. PCT/AU03/00937, filed on Jul. 25, 2003.

(51) Int. Cl. G06F 9/44

(52) U.S. Cl. 717/113; 717/112; 717/106

(57) ABSTRACT

The invention provides a bi-directional programming method/system/computer product for a programmer to enter source level instructions via either a visual language interface or a traditional syntactic level (code) interface. Irrespective of which means is used to describe the program, a corresponding “view” of the program (visual or syntax) is generated. Changes to the program can be made at either level, allowing the regeneration of the corresponding view (visual or syntax) to refect the changes. For example, should the original program be described in a visual format, then a program can be generated in the corresponding syntax level, then the equivalent version of the program can be regenerated in the visual format to reflect the changes. The invention can advantageously be used to develop back-end logic for an application program.

### TECHNICAL FIELD

The present invention relates to a new type of system or method for developing programs (i.e. software applications), and in particular, to a bi-directional programming system or method for assisting a user/programmer to develop computer programs.

### BACKGROUND ART

The concept of describing programs as flowcharts has been used since the invention of structured programming languages. Originally, these flowcharts were simply drawn on paper to reflect the design that the programmer intended to follow when implementing the program. More recently, flowchart drawing applications have been created thereby allowing a programmer to create digital documentation for their program, prior to implementation.

The basic flowchart element in such a drawing application is described as an abstract data type, or class. These drawing applications have generally been implemented using the following basic algorithm:

struct Element {

ElementType type;
Rect coords;
ElementPtr prev;
ElementPtr next;
VoidPtr userData;
String description;
String comment;

};

Where ElementType is defined as:

enum ElementType {

StartFlowchart, EndBlock, CallableStatement, IfClause,
ElseClause, SwitchClause, CaseClause, StartRepeat,
StartWhile, StartFor

};

The flowchart elements are constructed in a doubly linked list, with the option of an alternate link to represent an “else” condition. The element type defines the drawing algorithm necessary to create any given flowchart element. A flowchart data type can now be constructed by building a container to hold an ordered collection of flowchart elements.

Using this system, it is possible to provide an abstract view of some programming problems. However, in order to provide a more detailed implementation of the actual program being developed, a programming syntax (code) is used, and is compiled into a machine code format.

A computer system understands instructions provided to it as binary numbers, where each given binary number represents an instruction, and each such instruction is of a given length, with the binary numbers following the instruction being the parameters to the instruction. It is unusual and difficult for people to understand or program a computer in binary code. For this reason, high level languages were developed. High level languages aim to allow people to program computers in a language that more closely mimics the English language. Unfortunately, the English language cannot be expressed mathematically, and furthermore, contains enough contradictions in meaning that a computer cannot possibly be expected to understand common English language. So, just as with spoken/written languages, computer languages utilise a system of grammar. The prerequisite for any given computer language is that it is “parsable” (i.e. a computer algorithm can be developed to represent the meaning of the language in mathematical terms).

The flowchart illustrated in FIG. 1 (prior art) describes a presently known basic parsing algorithm for converting any abstract parsable language (syntactic code) to an intermediary form (byte code) that can then be converted to machine code (binary code).

In the field of program or software application development, programmers have historically used a text-based programming language (code) to pass commands to a computer. This code is terse and often difficult to understand. Typing code can be an error-prone and tedious exercise. In an attempt to somewhat automate the task of coding, several development companies have designed various automation solutions based on using pre-written templates or on using “scripts”, which are easier to write and which translate behind the scenes to code. The most outstanding achievement of companies involved in these endeavours was to succeed in creating a system which enabled programmers to build a user interface (UI) (the screens a user sees) by “drag and drop” visual methods. Code could then be automatically generated from the visual interface created by the “drag and drop” methods.

Presently, however, once the user interface is constructed, it is still necessary to type further code to actually make the program (i.e. the software application) do something other than act as a user interface. This part of programming is often referred to as “back-end logic building”.

It is presently known to provide a system for developing a user interface whereby a programmer is enabled to not only build a visual user interface and generate code from it, but also to then modify or add to the code and have the changes or additions reflected in the visual representation of the user interface. This is often referred to as “round-trip engineering” or “bi-directional programming”. For example, Microsoft Corp. commercialised such a concept in the product known as Visual Basic. However, it is most important to understand that such presently known technologies apply only to the construction of a user interface and not to back-end logic building.

As with most devices we buy, computer User Interfaces represent a static state within the machine or programme. Therefore, each interface within a program is representable as a static image. In the simplest case, it would be quite easy to represent program interfaces as a series of bitmap pictures, which the operating system is able to divide into the appropriate sections based on the coordinates of the mouse at the time an event occurred. However, this would incur a very significant amount of CPU time. To overcome this, an interface is defined as components which have a static (graphical part) and a dynamic (logic) part. For example, a button could take on many forms graphically, but our main interest in the button is when it is pressed, or released. This is known as an event.

A GUI designer such as that used by Visual Basic or Delphi, cannot remember, from one session to the next, which event a button is supposed to execute when it is pressed, or the position or dimensions of the button. To facilitate this, a file is written to disk which contains ‘hints’ to the IDE as to how to draw a button, and what should happen if it is pressed. This is known as a script. Systems such as Visual Basic and Delphi, contain their own proprietary scripts for this purpose. However, there are standard script definitions available. Some of the more well known ones are HTML, XML and Postscript. Note, that the layman's term ‘scripting languages’ is not used here, as the scripts generally do not represent a parsable language. In situations where the script is parsable, there is generally no concept of timing available (for example, HTML has no If/If-Else or Loop constructs available etc).

U.S. Pat. No. 5,911,070 (Solton et al.) discloses a development system with visual designer tools for generating and modifying program code. A user employs the visual designer tools to visually create an application program and generate a source file. The user can proceed to edit the source file with a text editor and then return to the visual designer tools at any time to edit a form visually. The user can use both techniques interchangeably, changes which occur in the visual designer tools are reflected in the generated source code and vice a versa. However, Solton et al. is only directed to the construction of a user interface and does not disclose a general means for round-trip software engineering as it more broadly relates to back-end logic building of a complete and functional program.

In contrast, however, a true visual programming language must by definition be able to represent a ‘program’ visually. A static script contains insufficient data to model the final solution. Graphical user interface development tools, like those provided with many modern compilers including Microsoft Visual C++, include highly visual components, but they are more graphics applications and template generators than actual programming languages.

Several types of Visual Programming Language (VPL) exist, as a result of multiple attempts to resolve the specific problems presented in trying to represent a series of time-sequenced events and actions visually. The various types include:
1. Purely visual languages: those which create a graphical environment in which the entire development and testing process is performed, and require the compilation of the program within the visual environment. These systems use proprietary “objects”, or blocks of pre-written code represented by graphical elements. The programmer assembles the application by arranging the objects in a sequence. Each object calls its related code. The code is not modifiable by the programmer in any way, and the quality of the compiled application is wholly determined by the quality of the pre-written code objects and the ability of the programmer to select and assemble the objects in the appropriate sequence.
2. Hybrid text/graphics systems, which generate code from graphical diagrams.
3. Programming-by-example systems, in which the programmer creates and manipulates graphical objects to “teach” the system how to perform a task.
4. Constraint-oriented systems, used for simulation design, in which the programmer models physical objects as objects in the visual environment which are subject to constraints designed to mimic the behaviour of natural laws, like gravity.
5. Forms based systems, broadly based on spreadsheet concepts, which represent programming as altering a group of interconnecting cells over time to allow the programmer to visualise the execution of the program as a sequence of different cell states.

The VPL systems listed above fall into one of two categories:
1. Stating modelling (i.e. “forms based” visual languages such as Visual Basic), which use graphical objects only to represent static states within the program, and therefore require the interspersion of a text based language in order to provide run-time activity. These languages do not attempt to facilitate the use of graphical elements to represent actions which occur in real-time.
2. Specialised modelling tools (eg. Sketchpad, Thinglab, ARK, etc), which provide ‘canned code’ style graphical objects to represent constants within our physical environment. As all fields of science contain absolute constants, this premise could be used to provide a modelling environment for many situations. Another example is tools such as Rational Rose, which use the same logic to model business processes/logic. As above, because the graphical elements are modelling static or constant states, the ‘program’ logic must be built using conventional code.

The graphical view for existing VPL's is not parsable. Hence, no presently known system truly provides round-trip engineering or bi-directional programming for back-end logic building of a general program.

This identifies a need to provide a new system or method for facilitating round-trip software engineering using flowcharts for use in back-end logic building of a program. This also identifies a need to provide a new system or method for a bi-directional programming system or method for assisting a programmer to fully develop a program which is not only a user interface. This also identifies a need to provide a new system or method for a bi-directional programming system or method where the graphical or visual view is parsable.

### DISCLOSURE OF INVENTION

In a broad form, the present invention seeks to provide a new system or method for facilitating round-trip software engineering utilising a visual representation for use in the back-end logic building of programs. In a further broad form, the present invention seeks to provide a system or method to facilitate back-end programming by providing that (a) editing at a source code level is automatically interpreted as edits in a flowchart representation which is correspondingly updated, and/or (b) existing code for back-end logic building can be read into a flowchart representation. This provides a means for a programmer to modify or add to back-end source code, as opposed to simply user interface code, which can then be automatically converted to a visual flowchart representation.

The present invention also seeks to provide a bi-directional programming system to allow a programmer to enter source level instructions into a computer system via either a visual (or graphic) language interface or a traditional syntactic level interface. Irrespective of which means is used to initially describe the program, a corresponding “view” of the program (visual or syntax) can be generated. Changes to the program can be made at either level, allowing the regeneration of the corresponding view (visual or syntax) to reflect the changes. For example, should the original program be described in a visual or graphical format, then a program with the same meaning can be generated in the corresponding syntax level format. Similarly, if a programmer wishes to make changes to this syntax level, then the equivalent version of the program can be regenerated in the visual view to reflect the changes.

The present invention provides a round-trip software development application for use in back-end logic building of programs in which the graphical view of the program is parsable. Because the graphical view is parsable, the data can be readily modelled using mathematics. This means that any other programming language that can describe the mathematical meaning can also be used for the graphical view. This way, the round-trip is facilitated by simply changing the current view of the program data.

In a particular embodiment of the invention, the underlying syntax level language used is the Java programming language, and the visual or graphic language is described by way of a flowchart diagram, structure diagram, work-flow diagram, parse tree or the like. Preferably, flowchart diagrams, structure diagrams, work-flow diagrams, or the like, are used to convey the visual view as most programmers are familiar with first describing a program in this manner prior to commencing the writing of source code. Similarly, the Java language may be used for the syntax view for its platform independence, hence preventing the program from being restricted to any specific operating system. In one embodiment of the invention, the byte-code language includes constructs selected from the following set: Assignment; Method Call; If Expression; If/Else Expression; For Loop; Repeat Clause; Do/While Clause; Switch/Case Expression; Synchronized; Try/Catch/Finally; End Block; or any other higher level language constructs

In a broad form of the present invention there is provided a method of developing a computer program using bi-directional programming means, the method including: (1) utilising a visual representation of the program that can be parsed and edited; and, (2) utilising a syntax code representation of the program that can be parsed and edited; (3) converting between the visual representation and the syntax code representation by converting the visual representation and the syntax code representation into byte-code representations and comparing the byte-code representations; wherein, edits in the visual representation are reflected in the syntax code representation, and vice versa, and the bi-directional programming means can be used to build back-end logic for the computer program.

Preferably, the visual representation is a flowchart or structure diagram, and the visual representation includes an extended flowchart element construct. In a particular form, the extended flowchart element construct includes at least: a callable statement mapping to a syntax language function call; a condition type clause having a condition part; and, a variable.

In a further broad form of the present invention there is provided a system for providing bi-directional programming means for developing a computer program, the system characterised by: (1) a visual representation of the program that can be parsed and edited; (2) a syntax code representation of the program that can be parsed and edited; (3) a processor to convert the visual representation to a byte-code representation and then convert the byte-code representation to the syntax code representation, or, to convert the syntax code representation to a byte-code representation and then convert the byte-code representation to the visual representation; wherein, edits in the visual representation are reflected in the syntax code representation, and vice versa, and the bi-directional programming means can be used to build back-end logic for the computer program.

In still a further broad form of the present invention there is provided a computer program product for use in developing an application program, said computer program product providing bi-directional programming means and comprising: (1) means to display a visual representation of the program that can be parsed and edited; (2) means to display a syntax code representation of the program that can be parsed and edited; (3) means to convert between the visual representation and the syntax code representation by converting the visual representation and the syntax code representation into byte-code representations and comparing the byte-code representations; wherein, edits in the visual representation are reflected in the syntax code representation, and vice versa, and the computer program product can be used to build back-end logic for the application program.

In a possible form of the present invention, the visual representation contains an extended element construct and includes primary native language semantics selected from the set of: a callable statement mapping to a syntax language function call; any other statement mapping to a syntax language assignment statement; a condition type clause having a condition part; a compound statement; error or exception handling; and/or, one or more variables. In a further form, the extended element construct contains a generic data structure for the visual representation including a start element, an end element and a means of representing a symbol table. In still a further form, the extended element construct contains a generic data structure for the representation of a collection of symbols or a symbol table. In yet still a further form, the extended element construct contains a generic data structure for the representation of an individual symbol. In still yet a further form, the extended element construct contains a generic data structure for the representation of an individual node of the visual representation.

### BRIEF DESCRIPTION OF FIGURES

The present invention should become apparent from the following description, which is given by way of example only, of a preferred but non-limiting embodiment thereof, described in connection with the accompanying figures, wherein:

FIG. 1 (prior art) illustrates a traditional ‘top-down’ parsing algorithm;

FIG. 2 illustrates a schematic showing flowchart to code steps;

FIG. 3 illustrates an aspect of the invention showing the complete round-trip or bi-directional cycle;

FIG. 4 illustrates an example of an embodiment of the invention in use—showing an initial flowchart representation;

FIG. 5 illustrates an example of an embodiment of the invention in use—showing the generated code;

FIG. 6 illustrates an example of an embodiment of the invention in use—showing amendments made by a programmer to the code;

FIG. 7 illustrates an example of an embodiment of the invention in use—showing the byte-code conversion;

FIG. 8 illustrates an example of an embodiment of the invention in use—showing the updated equivalent flowchart representation;

FIG. 9 illustrates an example of an embodiment of the invention in use—showing the code generated from the updated flowchart;

FIG. 10 illustrates a means of embodying particular forms of the invention;

FIG. 11 illustrates an example parse tree;

FIG. 12 illustrates the parse tree corresponding to FIG. 6;

FIG. 13 illustrates the parse tree corresponding to FIG. 9.

### MODES FOR CARRYING OUT THE INVENTION

The present invention provides a new bi-directional programming system or method for assisting a programmer to develop programs.

Preferred Embodiment

By forcing a controlled structure to be followed for the input of information, a flowchart diagram, structure diagram, work-flow diagram or the like allows a program to be described in a manner that more closely resembles either the English language, or whatever natural language a programmer desires to work with. However, in order to maintain a productive work environment, it is necessary to allow the programmer to continue to work in a familiar manner. Hence, the need for a bi-directional programming language allowing the programmer to also enter code.

Where the traditional means of describing a flowchart algorithmically is generally sufficient for documenting, and even in some cases generating function prototypes (headers), these traditional means do not provide sufficient information for generating a complete code based representation of an algorithm. However, by adding certain information to the flowchart element construct (over that which is presently known as discussed in the prior art section), a more complete meaning can be created.

Firstly, the concept of a callable statement is given an index, mapping to a syntax language function call, and any of the five condition type clauses (eg. IfClause, ElseClause, . . . ) is given a condition part. In addition, the concept of a variable is introduced, with the created variables given an index from 0 . . . n. Where n represents the total number of created variables, minus one. The flowchart description now contains both the collection of flowchart elements, and a collection of variables or symbols, the Symbol Table.

This extended flowchart element construct is indicated below:

struct Element {

ElementType type;
Rect coords;
ElementPtr next;
ElementPtr prev;
VoidPtr userData;
String description;
String comment;

};
Struct Flowchart {

ElementPtr StartElement;
ElementPtr EndElement;
SymbolTable symbols;

};
struct SymbolTable {

Integer symbolCount;
SymbolPtr firstSymbol;
SymbolPtr lastSymbol;

};
struct Symbol {

String name;
TypeIdentifier type;
String byteCodeRepresentation;
SymbolPtr next;
SymbolPtr prev;

};

In a preferred, but non-limiting, embodiment the remaining programming constructs then conform to the following rules:
1. A StartFlowchart clause can be followed by any other clause, or an EndBlock.
2. A CaseClause must always follow either a SwitchClause or another CaseClause.
3. A CaseClause may be followed by either another CaseClause (the empty case), one or more statements, or an EndBlock clause.
4. An IfClause must contain a condition part.
5. An IfClause must be followed by either any other clause except a StartFlowchart clause, or an EndBlock.
6. A Condition is defined as “statement; mathematic-condition; statement”.
7. A Statement is defined as a Variable or ComplexStatement, where a ComplexStatement is a combination of CallableStatements and Variables, representing a formula that is solvable to a primitive value. In this context, a primitive is defined as either an Integer, a Decimal Number, or a String of characters.
8. Both statements in a condition must resolve to equivalent primitive types.
9. All other conditional constructs (RepeatClause, WhileClause, ForClause) must follow the same set of rules.
10. A ForClause must be followed by two conditional clauses, a start condition and an end condition. Furthermore, the end condition of a ForClause must be followed by a Statement that resolves to an integer value, to increment the loop counter on each iteration.

Throughout our daily lives, most everything we do can be broken down into three distinct categories—Problems; Decisions; and Actions. The ‘problems’ usually arise as a result of a previous action. In programming, this is called an ‘event’. The way in which we react to an event, is known as a ‘method’ or ‘procedure’. Sometimes, a procedure, or part thereof, will need to be repeated a number of times, in order to extract the desired result. This is known as a ‘loop’.

A decision can be described as either:
If (some condition is true), then execute an action. End. OR
If (some condition is true), then execute action A, else execute action B. End.
   By allowing the nesting of these constructs, very complex decisions can be represented.

The final construct required by a programmer is called an ‘assignment’. This is the means by which a programmer can insert into a program, a mathematical formula based on known and unknown quantities. The composition of Assignments, Conditions, Loops and Procedures/Methods to arrive at a partial solution to the original problem, is known as an algorithm. A program is then created by analysing the original problem, breaking it down into a number of component problems, defining algorithms for each of these small problems, then assembling the algorithms into a single unit to solve the original problem.

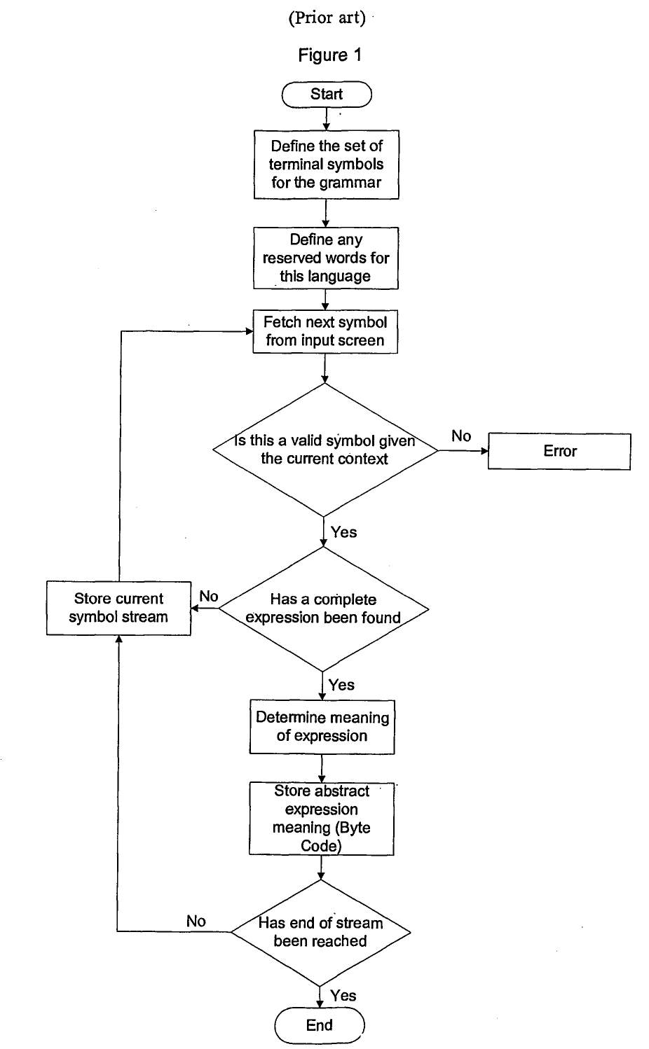

Using these basic rules, it is possible to describe a flowchart using a string of integer values, otherwise known as byte-code. As referred to for FIG. 1, byte-code is the intermediary language used to attempt to describe a program when converting syntax level code (source code) to machine code. If there is an error at this byte-code stage, then the compiler can report an error to the programmer as a “syntax error”, and the compilation will be aborted.

By representing the program at this byte-code level, a “view” can be created that describes the program in a manner that humans can more readily understand. The flowchart is considered the most desirable view to use, as this is readily understood by programmers and non-programmers alike.

The final stages of the traditional compiling process can then be used to convert the code into a machine readable instruction set, however, this is not the purpose of the present invention. Rather,. the present invention is concerned, in part, with converting the flowchart byte-code back to the equivalent syntax level code for manipulation by a programmer.

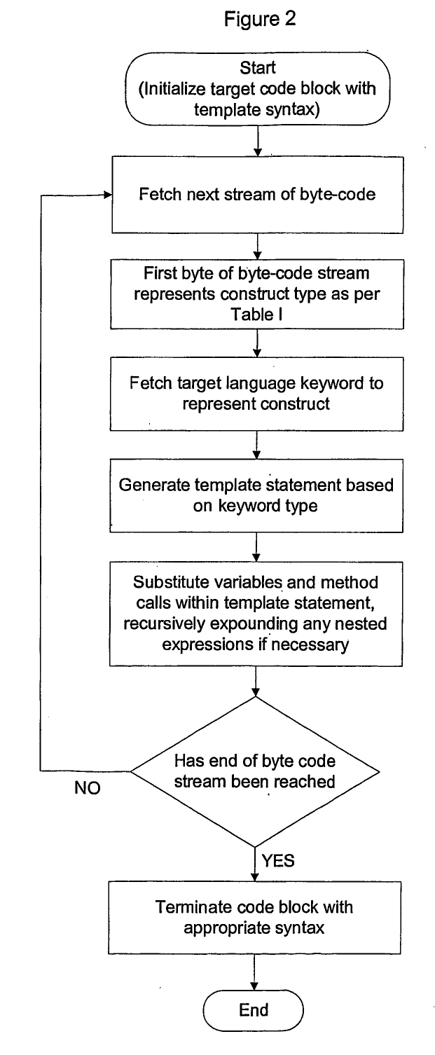

Referring to FIG. 2, the illustrated flowchart reverses the appropriate compilation steps, to convert the flowchart byte-code back to syntax code. The syntax level code may then be compiled using a standard compiler, or modified at the syntax level and converted back to a visual flowchart representation. At any point, the flowchart byte-code represents the target application accurately enough that it is always able to be compiled, hence satisfying the requirement for flowchart to syntax level code conversion.

Because the code modified by a programmer cannot, however, be guaranteed to be correct, a traditional parsing algorithm must be used to first verify the code prior to attempting to represent it as byte-code (viz. FIG. 1).

Once the programmer-modified code has been accurately converted back to byte-code, a flowchart visualisation can be readily re-drawn, or the byte-code may be converted to machine level instructions. The process can be used iteratively, until the programmer decides to output a set of machine level instructions thereby completing the application.

In the interests of simplicity, the final program can be converted back to byte-code, either transparently or deliberately, so that a standard compiler can be used to convert the program to machine code. However, as the program is, by definition, able to be compiled at this stage, the total compile time is significantly reduced.

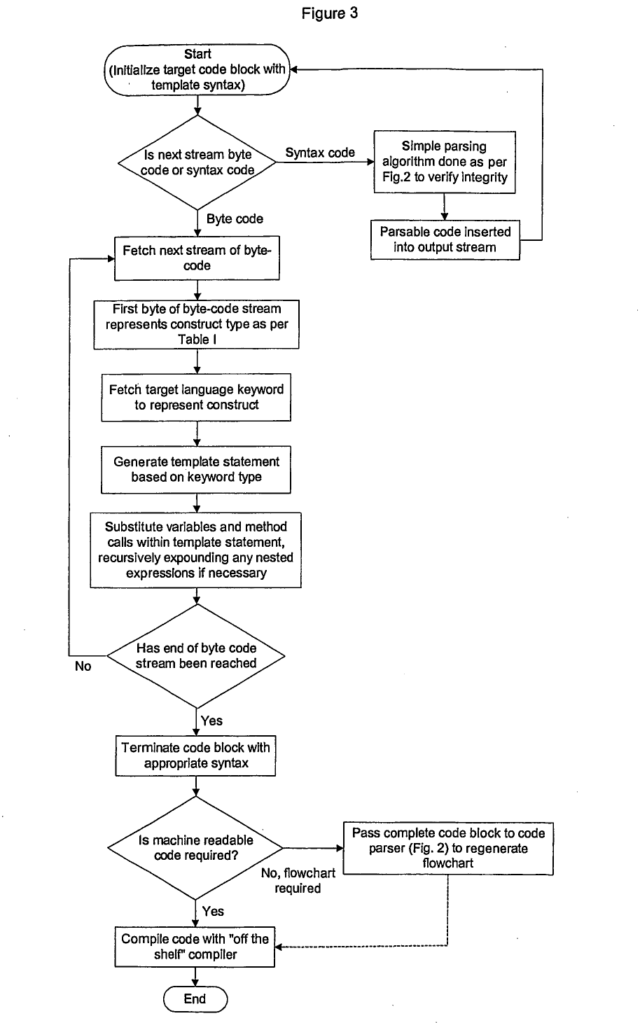

FIG. 3 illustrates the complete process for the present embodiment of a bi-direction programming language.

The following Table I shows basic byte-code language for use in the preferred embodiment.

TABLE I
Basic Byte Code Language.

| | | Byte Code Length |
|---|---|---|
| Byte | Construct | (bytes) |
| 1 | Assignment | 4 |
| 2 | Method Call | 3 + 1 byte per |
| | | parameter |
| 3 | If Expression | Variable according to |
| | | expression, but min 4 |
| | | bytes |
| 4 | If/Else Expression | Variable according to |
| | | expression, but min 5 |
| | | bytes |
| 5 | For loop | 1 + composition of 3 |
| | | sub-expressions (2 |
| | | assignments and If |
| | | condition) |
| 6 | Repeat Clause | 2 bytes + If condition |
| 7 | Do/While Clause | 2 bytes + If condition |
| 8 | Switch/Case | If condition for start + |
| | Expression | 1 byte per case. |
| | | (Nb. Each case task |
| | | can be viewed as a |
| | | nested block, |
| | | expressible by a |
| | | single procedure call). |
| 9 | End Block | 1 |

Table I provides a definition for a byte-code language that can graphically describe a basic visual language. Using this table as the data model of a traditional Document/Model/View program abstraction, a programmer can graphically represent the pseudo-code for any application.

In a particular embodiment, a software implementation of the present invention expands this byte-code, to graphically represent the semantic components of a defined expression. However, using the sample byte-code, this level of abstraction would need to be provided using traditional top-down parser logic (refer to FIG. 1).

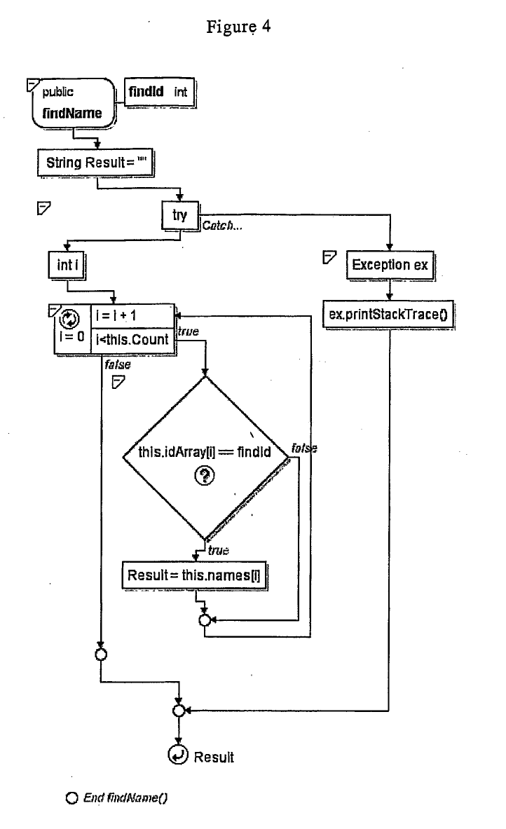

Presented in FIGS. 4 to 9 is an illustrative example of an embodiment of the invention in use. The example is intended to be merely illustrative and not limiting to the scope of the present invention. This example is presented as a series of steps which refer to the figures.

Step 1: (FIG. 4) Using a system or program embodiment of the present invention as an application program development environment the initial flowchart representation is created by selecting icons, which represent programming constructs, from a tool bar (not shown), selecting variables from a graphical ‘Variable Manager’ module (not shown), and entering parameters in response to prompts.

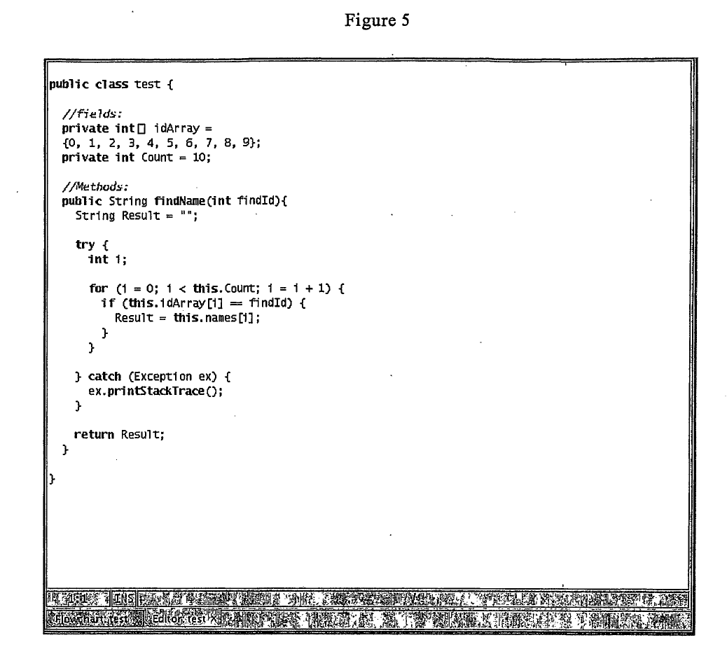

Step 2: (FIG. 5) The user selects a ‘Generate Java and View Source’ menu option (not shown), and the equivalent Java code is generated.

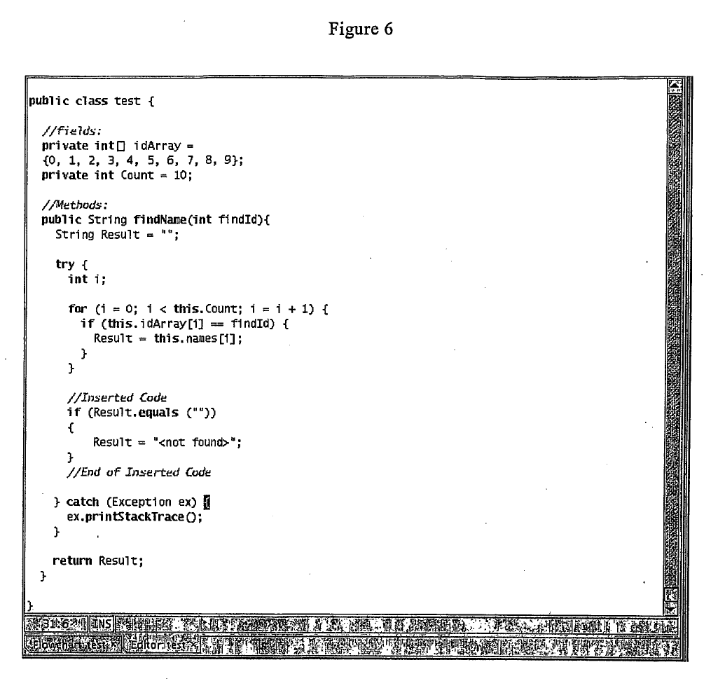

Step 3: (FIG. 6) The Java code can then be modified by a programmer, by inserting additional code or making changes to the code. In this example, an addition has been made following the marker “//Inserted Code”.

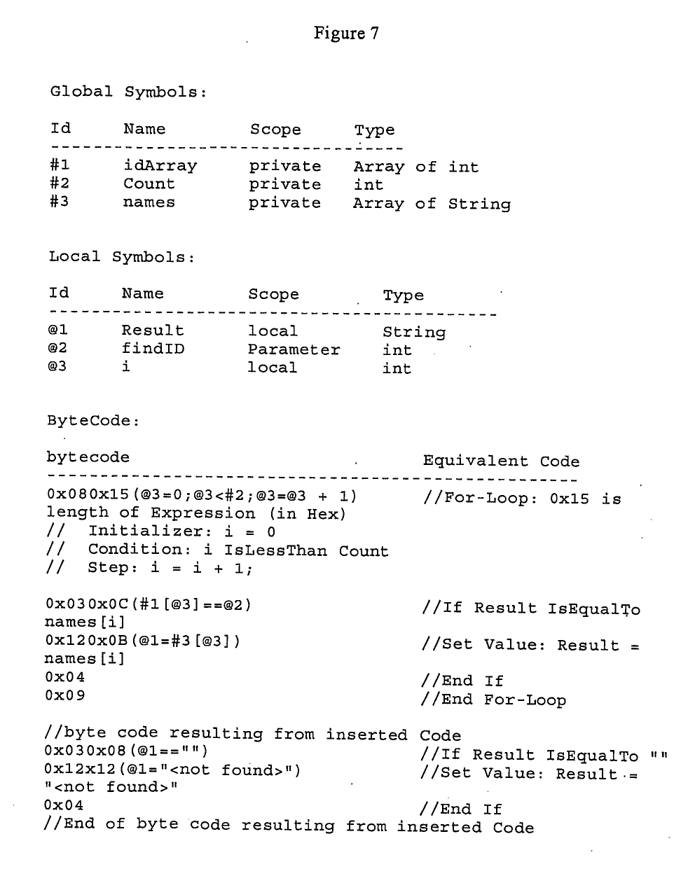

Step 4: (FIG. 7) Transparently to the end user, the development system or program converts the code to a byte-code equivalent.

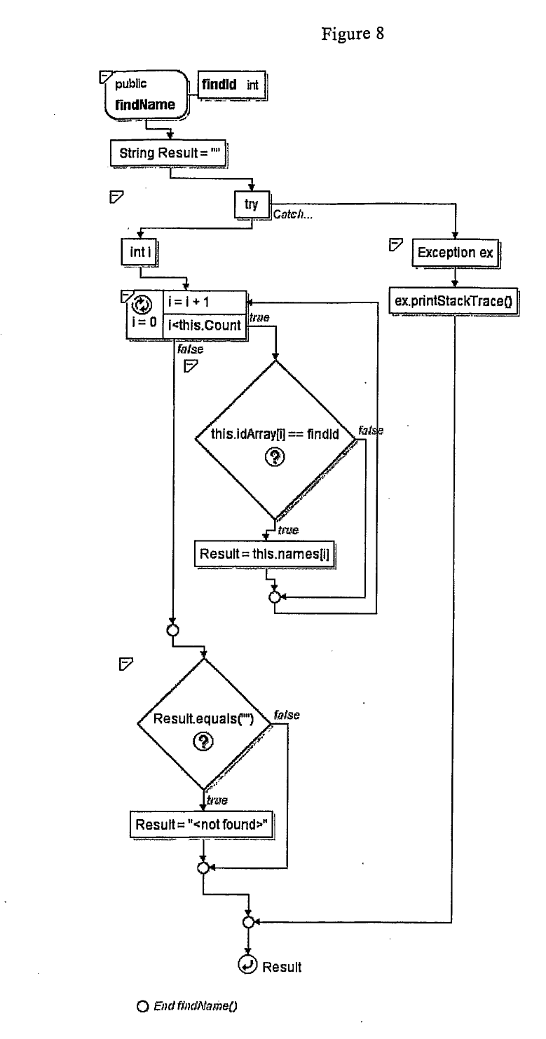

Step 5: (FIG. 8) The equivalent flowchart representation, now reflecting the alteration to the Java code made by the programmer at syntax level, is generated and displayed.

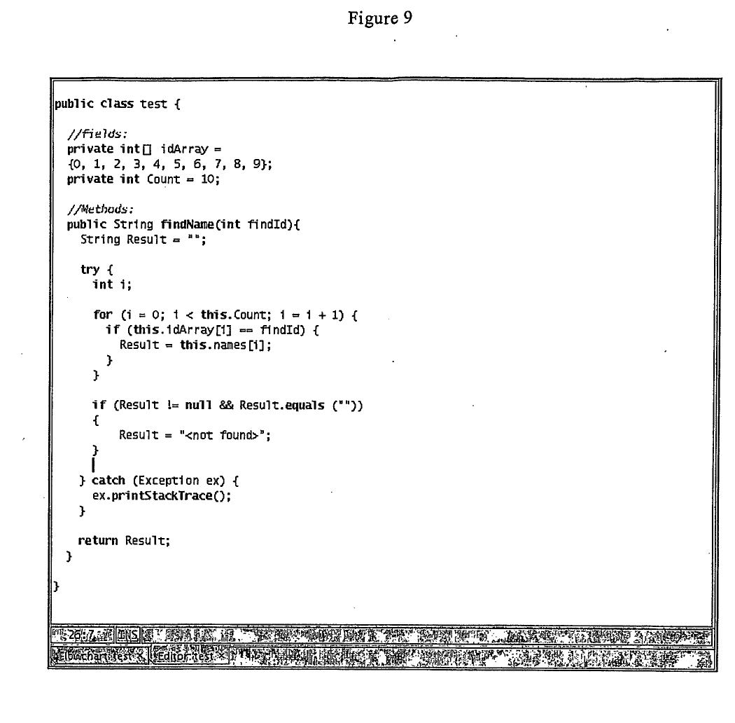

Step 6: (FIG. 9) From the modified flowchart, corresponding Java code can again by generated and viewed. Note that the “//Inserted Code”, marker is no longer present as the code now exactly matches the flowchart from which it was created. Of course, the option exists to graphically modify the flowchart in FIG. 8 prior to re-generating the Java code, in which case the generated code would reflect any changes made at the graphical flowchart level.

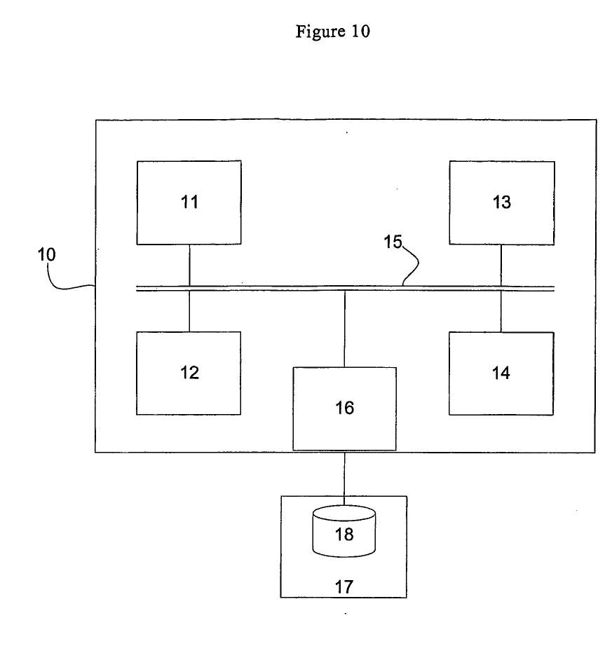

A particular embodiment of the present invention can be realised using a processing system, an example of which is shown in FIG. 10. In particular, the processing system 10 generally includes at least a processor 11, a memory 12, an input device 13 and an output device 14, coupled together via a bus 15. An external interface 16 can also be provided for coupling the processing system 10 to a storage device 17 which houses a database 18. The memory 12 can be any form of memory device, for example, volatile or non-volatile memory, solid state storage devices, magnetic devices, etc. The input device 13 can include, for example, a keyboard, pointer device, voice control device, etc. The output device 14 can include, for example, a display device, monitor, printer, etc. The storage device 17 can be any form of storage means, for example, volatile or non-volatile memory, solid state storage devices, magnetic devices, etc.

In use, the processing system 10 is adapted to perform various functions, such as execute application programs, perform computer readable instructions, convert between data types, compile or parse code, and allow data or information to be stored in and/or retrieved from the database 17 or information source via a network. The processor 11 receives instructions via the input device 13 and displays results to a user via the output device 14. It should be appreciated that the processing system 10 may be any form of processing system, such as a computer terminal, server, specialised hardware, personal computer (PC), mobile data terminal, portable computer, personal digital assistant (PDA), or any other similar type of electronic device.

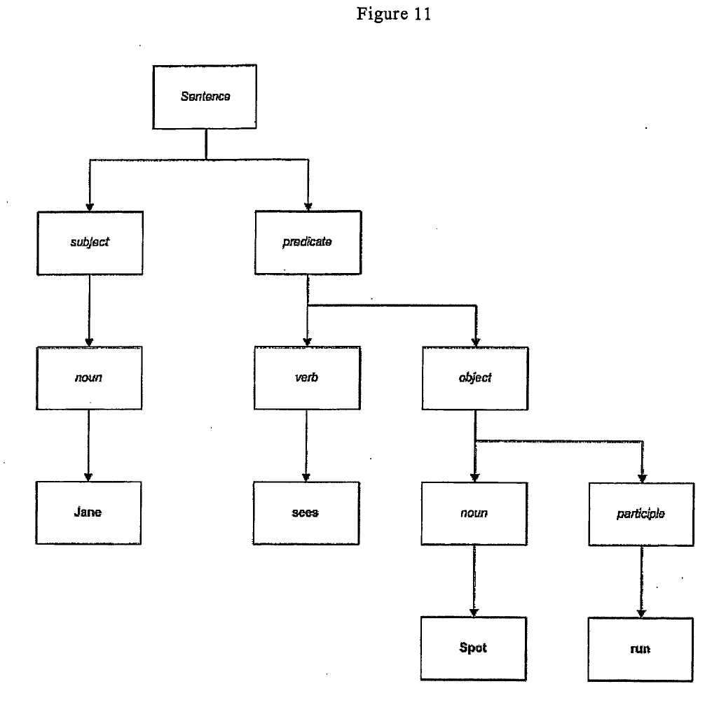

A further alternative embodiment of the invention involves replacing the flowchart data structure with that of a conventional parse tree. The parse tree is generally used in language processing to de-compile the meaning of a sentence based on the grammatical make-up. For example, the English sentence “Jane sees Spot run” could be represented by the parse tree illustrated in FIG. 11.

Conventionally, a parse tree is created by a compiler to represent the data structure that defines the meaning of a given block of code. On creation of the parse tree, the parser may reach error states as indicated in the simple parse algorithm shown in FIG. 1. These error states may or may not affect the creation of the parse tree. For example, semantic errors such as the referencing of a variable that has not been previously declared, can cause the tree to lack sufficient meaning to be able to generate a final program. Syntactic errors, such as the failure to terminate a statement with the appropriate symbol, usually a full stop in every day language, or unbalanced parenthesis in a mathematical formula, will cause sufficient disruption so that a parse tree cannot be created. According to this particular embodiment of the invention, neither situation poses a significant problem. By manipulating the tree nodes graphically, it can be guaranteed that syntactic errors do not occur. Similarly, although it is important to the dynamics of building a piece of software, that semantic errors are allowed to occur from time to time, it is still possible to block other operations within a software tool embodying the invention until such time as these errors have been rectified. The challenge then turns to how this is controlled when manipulating the source code in a conventional editor.

By employing an incremental compilation strategy, the parse tree can be generated “on the fly” as the programmer types code. This tool strategy is currently used by code editors that implement a feature known as “syntax hi lighting” to assist the programmer. However, where such tools leave any errors either syntactic or semantic simply marked in red, it is essential for the purpose of bi-directional programming, that syntactic errors be treated much more severely.

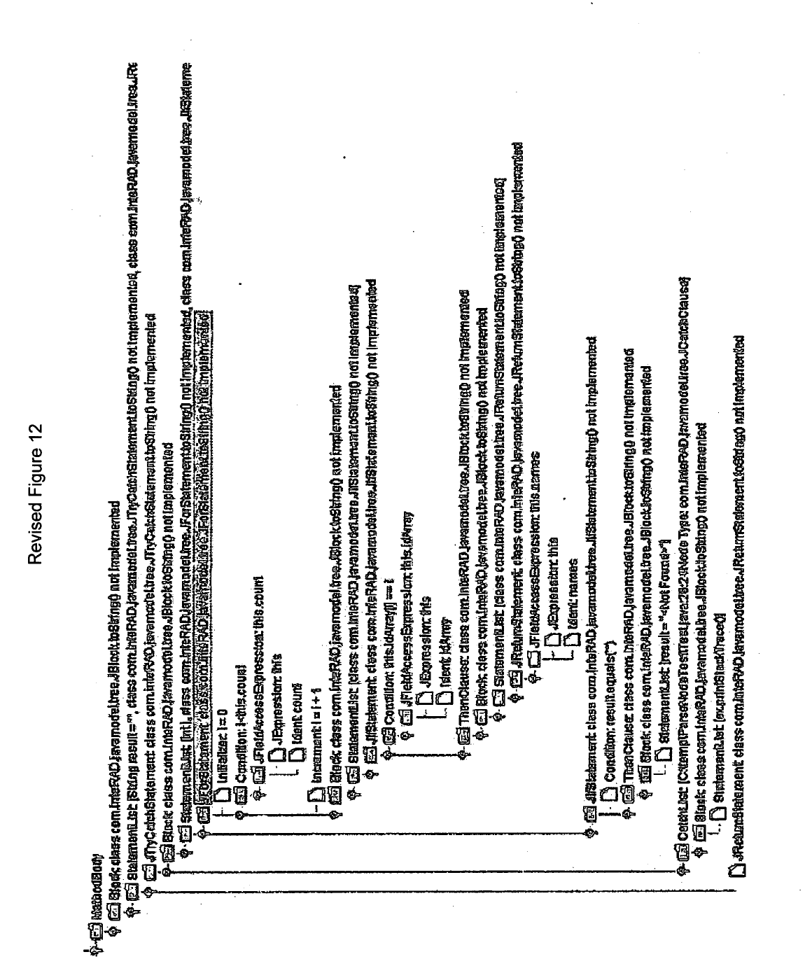

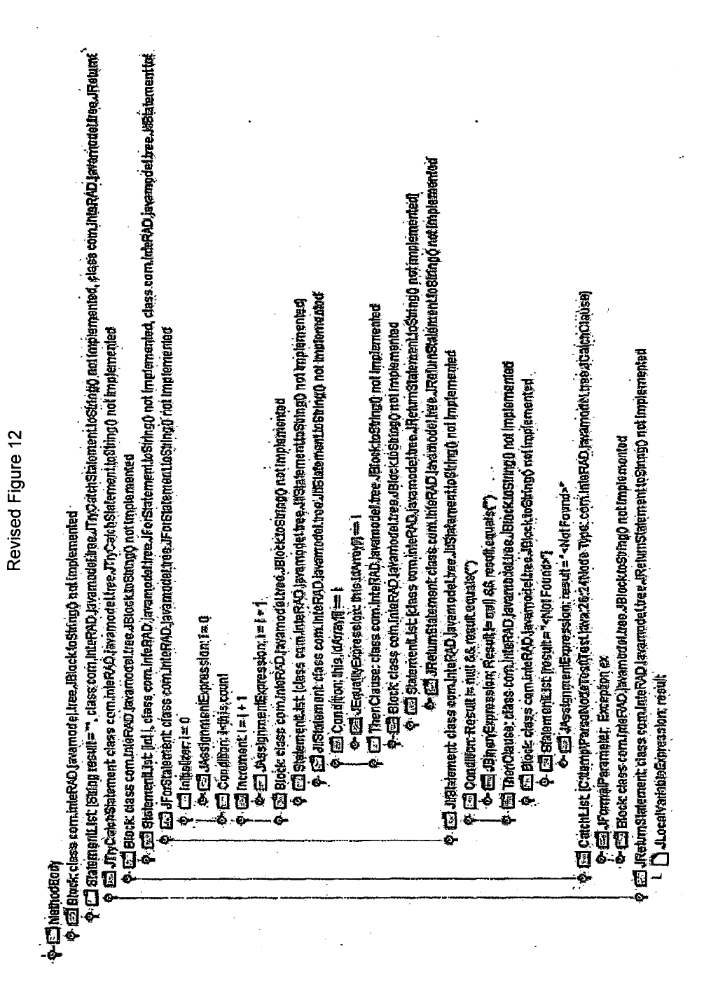

Unfortunately, given that a parse tree cannot be created when a syntactic error occurs, it is largely impossible to detect the exact location of such an error. For this reason, the strategy that has been taken is to block a number of the tool features until such time as the error has been corrected. Examples of features that would be blocked, are the option to compile, or translate the view back to a graphical view and hence manipulate the project in a graphical mode. The parse trees for corresponding to FIGS. 6 and 9 are represented in FIGS. 12 and 13 respectively.

Thus, there has been provided in accordance with the present invention, a bi-directional programming system or method for assisting a programmer to develop programs which satisfies the advantages set forth above.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the spirit or scope of the present invention.

1. A method of developing a computer program using bi-directional programming means, the method including:
(1) utilising a visual representation of the program that can be parsed and edited; and,
(2) utilising a syntax code representation of the program that can be parsed and edited;
(3) converting between the visual representation and the syntax code representation by converting the visual representation and the syntax code representation into byte-code representations and comparing the byte-code representations;
wherein, edits in the visual representation are reflected in the syntax code representation, and vice versa, and the bi-directional programming means can be used to build back-end logic for the computer program.

2. The method as claimed in claim 1, wherein the visual representation is a flowchart diagram, structure diagram, work-flow diagram, parse tree or the like.

3. The method as claimed in claim 2, wherein the visual representation includes an extended flowchart element construct.

4. The method as claimed in claim 3, wherein the extended flowchart element construct includes at least:
a callable statement mapping to a syntax language function call;
a condition type clause having a condition part; and,
a variable.

5. The method as claimed in claim 4, wherein other flowchart element constructs are provided and conform to predefined rules.

6. The method as claimed in claim 1, wherein a parsing algorithm is used to verify the visual representation or the syntax code representation prior to conversion to byte-code representations.

7. The method as claimed in claim 1, wherein edits in the visual representation and the syntax code representation can be performed iteratively.

8. The method as claimed in claim 1, wherein the bi-directional programming means can also be used to build a graphical user interface for the computer program.

9. The method as claimed in claim 1, wherein edits in the visual representation are automatically reflected in the syntax code representation, and vice versa.

10. The method as claimed in claim 1, wherein pre-existing syntax code can be read and converted into a visual representation.

11. The method as claimed in claim 1, wherein at any stage of development the byte-code common to the visual representation and the syntax code representation can be compiled into machine level code.

12. A system for providing bi-directional programming means for developing a computer program, the system characterised by:
(1) a visual representation of the program that can be parsed and edited;
(2) a syntax code representation of the program that can be parsed and edited;
(3) a processor to convert the visual representation to a byte-code representation and then convert the byte-code representation to the syntax code representation, or, to convert the syntax code representation to a byte-code representation and then convert the byte-code representation to the visual representation;
wherein, edits in the visual representation are reflected in the syntax code representation, and vice versa, and the bi-directional programming means can be used to build back-end logic for the computer program.

13. The system as claimed in claim 12, wherein the visual representation contains an extended flowchart element construct which includes primary native language semantics selected from the set of:
a callable statement mapping to a syntax language function call;
any other statement mapping to a syntax language assignment statement;
a condition type clause having a condition part;
a compound statement;
error or exception handling; and/or,
one or more variables.

14. The system as claimed in claim 12, wherein there is additionally provided a parsing algorithm to verify the visual representation or the syntax code representation prior to conversion to byte-code representations.

15. The system as claimed in claim 12, wherein the byte-code language includes constructs selected from the following set: Assignment; Method Call; If Expression; If/Else Expression; For Loop; Repeat Clause; Do/While Clause; Switch/Case Expression; Synchronized; Try/Catch/Finally; End Block; or any other higher level language constructs.

16. The system as claimed in claim 12, wherein the visual representation is a flowchart diagram, structure diagram, work-flow diagram, parse tree or the like.

17. A computer program product for use in developing an application program, said computer program product providing bi-directional programming means and comprising:
(1) means to display a visual representation of the program that can be parsed and edited;
(2) means to display a syntax code representation of the program that can be parsed and edited;
(3) means to convert between the visual representation and the syntax code representation by converting the visual representation and the syntax code representation into byte-code representations and comparing the byte-code representations;
wherein, edits in the visual representation are reflected in the syntax code representation, and vice versa, and the computer program product can be used to build back-end logic for the application program.

18. The computer program product as claimed in claim 17, wherein the visual representation includes an extended flowchart element construct.

19. The computer program product as claimed in claim 17, wherein the visual representation contains an extended element construct and includes primary native language semantics selected from the set of:
a callable statement mapping to a syntax language function call;
any other statement mapping to a syntax language assignment statement;
a condition type clause having a condition part;
a compound statement;
error or exception handling; and/or,
one or more variables.

20. The computer program product as claimed in claim 19, wherein the extended element construct contains a generic data structure for the visual representation including a start element, an end element and a means of representing a symbol table.

21. The computer program product as claimed in claim 19, wherein the extended element construct contains a generic data structure for the representation of a collection of symbols or a symbol table.

22. The computer program product as claimed in claim 19, wherein the extended element construct contains a generic data structure for the representation of an individual symbol.

23. The computer program product as claimed in claim 19, wherein the extended element construct contains a generic data structure for the representation of an individual node of the visual representation.

24. The computer program product as claimed in claim 19, wherein the extended element construct is an extended flowchart diagram, structure diagram, work-flow diagram or parse tree element construct.
